(19) United States
(12) Patent Application Publication
(10) Pub. No.: US 2019/0379645 A1
(43) Pub. Date: Dec. 12, 2019

(54) SYSTEM FOR SECURE ARBITRARY DATA TRANSPORT

(71) Applicant: TELUS Communications Inc., Vancouver (CA)

(72) Inventors: Garett Beukeboom, Maple (CA); Peter Tanner, Markham (CA)

(73) Assignee: TELUS Communications Inc., Vancouver (CA)

(21) Appl. No.: 16/039,741

(22) Filed: Jul. 19, 2018

(30) Foreign Application Priority Data
Jun. 11, 2018 (CA) 3007825

(51) Int. Cl. H04L 29/06; H04L 9/08; G06F 21/60

(52) U.S. Cl. CPC H04L 63/0435; H04L 63/061; G06F 2221/2107; H04L 9/0861; G06F 21/602; H04L 63/18

(57) ABSTRACT

Methods of communicating and facilitating secret communication are provided, with the steps of having a first party provide an encryption key to a first client and a decryption key to a second client, having the first client generate a first and second information, both in combination forming the secret communication, first client encrypting the first information with the encryption key and sending the encrypted information to the second client by an independent communication channel such as a third party server, having the first client send the second information to the second client through the first party, having the second client decrypt the encrypted information with the decryption key to recover the first information, and second client combining the first and second information to recover the secret information.

### TECHNICAL FIELD

Encrypted and secret communication.

### BACKGROUND

There's a basic problem with encrypted communication currently, key exchanges: if two systems (be they people. services etc.) want to communicate using encryption they must first have keys which can be used to encrypt/decrypt the messages from the other party. The issue becomes, if the two systems must first exchange keys before they can communicate securely, how do they exchange the initial keys?

Most systems in market work around, this problem by distributing keys in secured lockers; SIM cards for cell phones, trusted hardware modules on laptops etc. For already in-market and untrusted systems the ability to transport keys is much more complex.

### SUMMARY

There is disclosed a method of communicating secret information from a first client to a second client, where the first client receives an encryption key from a key generating server, and the second client receives a decryption key from the key generating server. According to this method, the first client may generate a first information and a second information, which in combination represent the secret information. The first information is encrypted with the encryption key to generate encrypted information. The second information is sent to the second client through a relaying server. The encrypted information is sent to the second client via an communication channel independent of the relaying server and the key generating server. The second information is sent to the second client through a relaying server. The second client can then decrypt the encrypted information with the decryption key received from the first party to recover the first information. The second party may then combine the first and the second information to recover the secret information.

There is also disclosed a first and second non-transient computer readable medium containing program instructions which facilitate the communication of secret information between a first user and a second user. The program instructions may include instructions to carry out the steps carried out by the first and second client as described above.

There is also provided a method of facilitating communication of secret information between a first client and a second client by generating an encryption key and a decryption key; sending the encryption key to the first client; and sending the decryption key to the second client. The method may also cause the first client to generate first information and second information that in combination represent the secret information; encrypt the first information using the encryption key to produce encrypted information; send the second information to a server; and send the encrypted information to the second client via a communication channel independent of the server. The method, may also include the step of, at the server, sending the second information to the second client.

In various embodiments, there may be included any one or more of the following features: where the encryption and decryption keys are identical; where the first information is an additional decryption key used to encrypt the second information; and where the additional decryption key is an encryption key used to produce the second information.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a schematic diagram showing an arrangement of entities carrying out a first stage of a data transport method.

FIG. 2 is a schematic diagram showing an arrangement of entities carrying out a second stage of a data transport method.

FIG. 3 is a flow chart showing method steps carried out by a first client sending secret information and a second client receiving the secret information.

FIG. 4 is a flow chart showing method steps carried out by a first party server.

FIG. 5 is a flow chart showing steps that the server in FIG. 4 causes a first client to carry out.

FIG. 6 is a schematic diagram showing an authentication system.

### DETAILED DESCRIPTION

Immaterial modifications may be made to the embodiments described here without departing from what is covered by the claims.

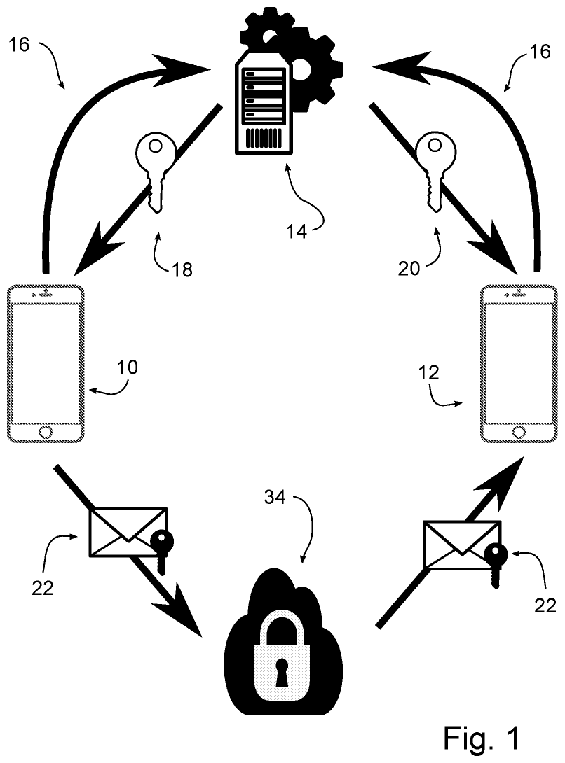

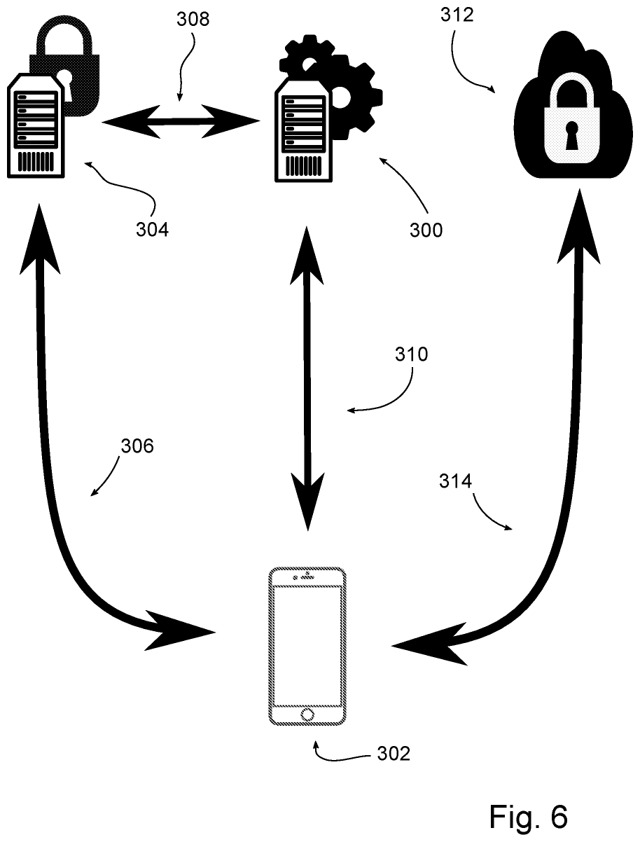

There is provided a System for Secure Arbitrary Data Transport (SSADT). For illustrative purposes, the operation of the SSADT is shown for two clients. A first stage of the SSADT is illustrated in FIG. 1. As shown in FIG. 1, a first client 10 and a second client 12 authenticate to a first party key generating server 14 using communications 16. Any conventional authentication method may be used. In an example embodiment, a separate authentication server (shown in FIG. 6) communicating with the clients and the key generating server may be used. The communications between the clients and the key generating server, and between servers, may be secured against other parties in any conventional manner. For example, SSL or TLS may be used. Referring to FIG. 1, the first party key generating server 14 generates an encryption key 18 which it sends to first client 10 and a decryption key 20 which it sends to second client 10. Symmetric cryptography may be used, in which case the encryption key 18 and decryption key 20 may be identical, as shown in FIG. 1. First client 10 may encrypt a secret message using the encryption key 18 to produce an encrypted message 22. First client 10 sends encrypted message 22 to second client 12 via a communication channel independent of the key generating server 14, which ensures that the encrypted message 22 and the keys 18 and 20 are not transported through the same channel. For example, the communication channel may be a third party server 34. Third party server 34 may have its own conventional secured connections with each of the clients, protecting the communications against other parties including the first party. Second client 12, upon receiving the encrypted message 22, may decrypt the message using decryption key 20. The cloud shapes around the first party server 14 and third party server 34 in the embodiment shown arc meant to denote that they exist and are accessible on the internet.

As neither the first party nor the third party has the capability to read the messages sent between the clients and the other of the first and third party, neither can recover the secret information. Even if the security of one of the first party and third party is broken, the secret information would remain safe against anyone other than the other of the first and third parties.

The clients may be assigned random IDs, for example by the key generating server, and the servers and peer-to-peer connection may use these random IDs rather than, for example, user names. In an embodiment using a separate authentication server, for example only the authentication server may know the user names. In an embodiment, the third party server may have an authentication system to which clients may subscribe using separate credential than those used for the SSADT.

The encryption key 18 and decryption key 20, which may be the same, may be used in an encryption/decryption algorithm that also uses another piece of information in the encryption (referred to here as an initialization vector (IV)). For example, AES 256 may be used. In an embodiment, an IV may be based on a message hash and sent with the message. In an embodiment, the system maintains contact lists for each user. In an embodiment, an encryption key 18 and corresponding decryption key 20, which may be the same, are produced for each pair of mutual contacts. In an embodiment, the key pairs are refreshed every 30 days.

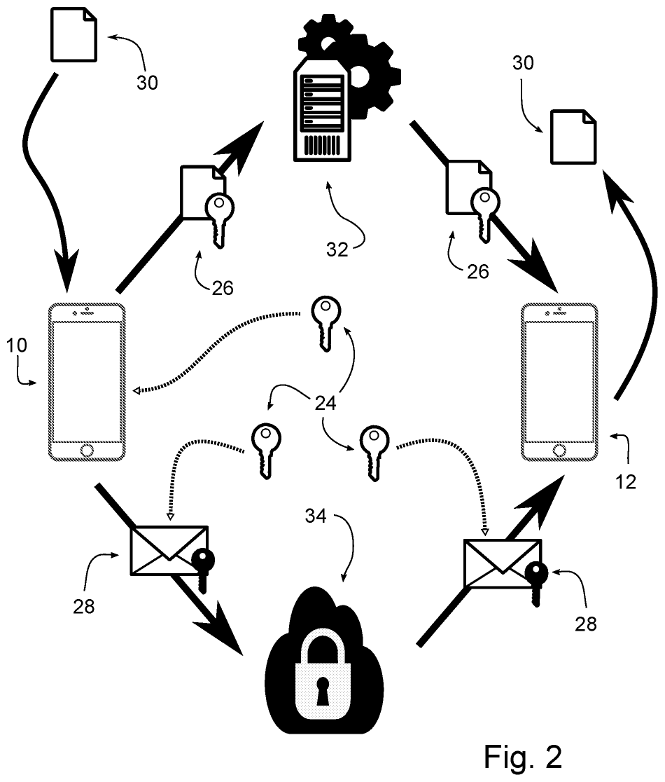

A second stage of the SSADT is illustrated in FIG. 2. As shown in FIG. 2, the first client 10 has secret information 30 which it uses to produce first information 24 and second information 26 which can be combined to recover the secret information 30. One of the first information 24 and the second information 26 may be a decryption key and the other an encrypted version of the secret information 30 that may be decrypted using the decryption key. Symmetric cryptography may be used, so that the decryption key is also an encryption key used to encrypt the secret information 30. The encryption key may be a one time use encryption key used only to encrypt and decrypt secret information 30. In the example shown, first information 24 is a encryption/decryption key and second information 26 is a file made by encrypting the secret information with first information 24. First information 24 may be encrypted using, for example, the encryption key 18 from stage 1 of the SSADT to generate encrypted information 28. First client 10 may send the encrypted information 28 to second client 12 through an independent communication channel, such as the third party server 34 as shown in the example of FIG. 2. In an example, the third party server may be a third party storage server, such as for example Google™ Drive, Box™, DropBox™ etc. The third party storage server may be used in the conventional manner, and need not treat the files stored on the third party server as a result of this method any differently than other files stored on the third party server. The term “independent” means that any party controlling the relaying server or key generating server cannot read it. Such a channel may be independent even if it travels across a node controlled by a first party that controls the relaying server and key generating server, if it is encrypted to secure it against parties including the first party. Second information 26 is sent from first user 10 to second user 12 through a relaying server 32 which may be the same as key generating server 14 as shown in FIG. 2 or under control of the party controlling the key generating server 14, but separate from the communication channel used to transmit encrypted information 28. This ensures dichotomy of transmission between the encryption key and the encrypted information, similar to that present in the first stage of the SSADT. In addition, different parties may handle the key generating server 14 and relaying server 32. Whether the relaying server 32 and key generating server 14 are the same or different, the clients may authenticate onto the relaying server 32 and key generating server 14 by pre-arranged means and may use encrypted communications such as SSL or TLS. Either or both of the key generating server 14 or the relaying server 32 may be cloud entities rather than a single server. First party servers may be implemented on hardware controlled by the first party directly or by another party, for example a cloud provider such as Amazon™ Web Services (AWS). In an example, the relaying server is an S3 instance at AWS, and the key generating server is an EC2 instance at AWS. The third party server 34 may also be a cloud entity. By using secured communications between the clients and the servers, the vulnerability of the system to interception of the clients' communications is reduced. The third party server may also have an authentication system. Upon receipt of encrypted information 28, second client 12 may use decryption key 20 to decrypt encrypted information 28 to obtain first information 24. Second client 12 may then combine first information 24 and second information 26 to recover secret information 30.

This second stage provides additional security in at least that an attacker would need to obtain all three of the decryption key 20, second information 26 and encrypted information 28 in order to recover the secret information 30.

The activities shown need not take place at the same time. For example, the first client and second client need not be online at the same time. The second client may be given a notification indicating that a communication is available and instructions for receiving the communication. A notification may be sent by the third party server. In an embodiment, the third party server is a service that sends notifications. For example, PubNub™ may be used. In another embodiment, a notification server is used in addition to the third party server. The second client may, having received the notification, then request and receive communications from the first and third party servers. In an embodiment, the relaying server is not told by the first client who to send the first information to. Instead, the first client receives, for example, a JSON token from the server containing all information needed to access and download the first information. The first client may send the JSON token to the second client using stage 1 of the SSADT.

All messages and files may be uniquely encrypted/named on device as disclosed above. The servers used to relay the messaging or files may never be aware of the UserID, contents or location, therefore in the unlikely event a message or file is intercepted an attacker would not have the information required to connect the pieces together. For example, the relaying server may store the second information (e.g. encrypted file), the key generating server may manage the UserIDs and encryption/decryption key, and the third party server may manage the first information (additional decryption key).

In an embodiment where the encryption key 18 and decryption key 20 are generated in respect to a particular document, the SSADT may also be used with additional clients. The first client may authorize the first party to share the encryption key 18 and second information 26 with an additional client, and also give the additional client authorization to access the first information 24 at the third party server. The first party may also allow the first client 10 to request the second information 26 and encryption key 18, and the third party may allow the first client 10 to request the first information 24. If the first and third parties have a policy of allowing these requests, the first client 10 may delete the first and second information locally and still recover the secret information 30 in, the same manner that the second party 12. Thus, the SSADT may be used as a shared storage service by any number of clients. The second client 12 may also be omitted so that the SSADT acts as a secured storage service for individual clients.

There is also provided a first and second non-transient computer readable medium containing program instructions which facilitate the communication of secret info, nation between a first user and a second user. The program instructions may include instructions to carry out the steps carried out by first client 10 and by second client 12 as described above. A single computer readable medium may include instructions for the steps carried out by both clients. Multiple computer readable media could also be used, for example one medium containing instructions for the steps carried out by first client 10 above and another medium containing instructions for the steps carried out by second client 12 above. The mention of a first computer readable medium and a second computer readable medium in the claims do not preclude the first and second, computer readable medium being the same nor do these terms preclude either or both of the first and second computer readable media comprising multiple computer readable media.

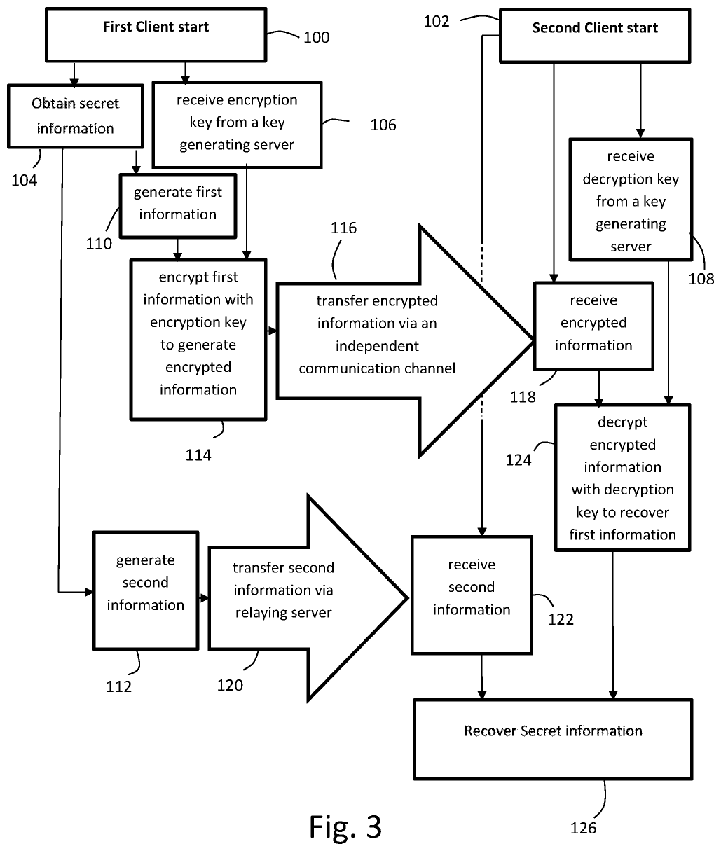

FIG. 3 is a flow chart showing steps carried out by a first client and a second client to implement a method of communicating secret information from the first client to the second client. The multiple paths through the flow chart are indicative of the lack of need for a strict order between steps and each path may be taken in parallel. Here and in all flow charts in this document, the presence of a sequence of steps in an order in a path through the flow chart does not however necessarily indicate that they must be done in that order. The order shown is an exemplary order. Step 100 indicates a starting state for a first client and step 102 indicates a starting state for a second client. In step 104, the first client obtains secret information that it wishes to securely transmit to the second client. The secret information may be from any source or generated locally by the first client. In step 106, the first client receives an encryption key from a key generating server. In step 108, the second client receives a decryption key from the key generating server. The encryption key and decryption key may be identical. In step 110 the first client generates first information and in step 112 the first client generates second information. In combination, the first information and second information represent the secret information. One of the first information and second information may be an additional decryption key to decrypt the other of the first information and second information to recover the secret information. The additional decryption key may be generated either before or after the secret information is obtained. In an example, the additional decryption key may be a single use decryption key, as no other documents are produced that may be decrypted by it. The decryption key may also be an encryption key to encrypt the secret information to produce the other of the first information and second information. In step 114, the first client encrypts the first information with the encryption key to generate encrypted information. In step 116, the first client sends the encrypted information to the second client via a communication channel independent of the key generating server and the relaying server mentioned below, such as by a third party server as shown. In step 118, the second client receives the encrypted information. The first client sends the second information to the client via a relaying server as shown in step 120, for transfer to the second client. The relaying by the first party and third party servers need not be immediate. For example, the second client may not be online when the first party sends the information and may receive a notification from the first party server to request the information from the first party and third party servers. In step 122, the second client receives the second information from the first party server. In step 124, the second client decrypts the encrypted information using the decryption key to recover the first information. In step 126 the second client combines the first information and the second information to recover the secret information.

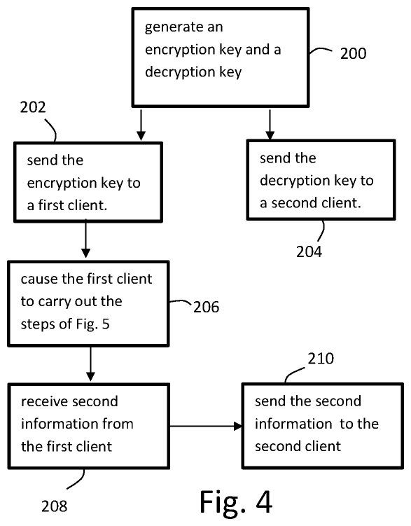

FIG. 4 is a flow chart showing steps carried out, for example by a first party or by multiple parties, to implement a method of communicating secret information between a first client and a second client. The steps may be implemented by a server or multiple servers. In step 200, an encryption key and a decryption key are generated. The encryption key and decryption key correspond to each other in that the decryption key decrypts the encryption of the encryption key, and the keys may be identical. In step 202, the encryption key is sent to the first client. In step 204, the decryption key is sent to the second client. In step 206, the first client is caused to carry out the steps shown in FIG. 4. In step 208 a server receives second information from the first client. In step 210, the server sends the second information to the second client.

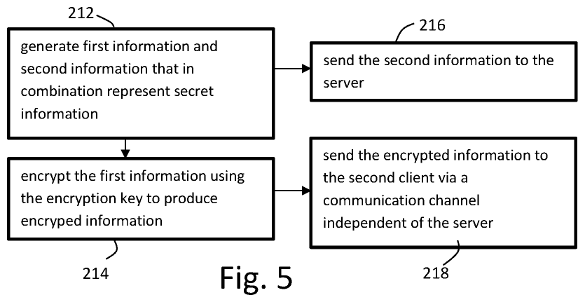

FIG. 5 is a flow chart showing steps that a party implementing step 206 of 4, for example a first party, causes the first client to carry out. The first party causes the first client to, in step 212 generate first information and second information that in combination represent the secret information, in step 214 encrypt the first information using the encryption key to produce encrypted information, in step 216 send the second information to a server, and in step 218 send the encrypted information to the second client via a communication channel independent of the server. The server may be controlled by the first party. A server not controlled by the first party may also be used, so long as it will relay the information to the second party.

FIG. 6 shows an example of server communications and authentication with a client. A backend server 300, which may be for example a relaying server, communicates with client 302 and authentication server 304. The authentication server may be a key generating server. The client 302 logs in to authentication server 304 using communication 306. The authentication server then communicates with backend server 300 using communication 308 to arrange an authenticated communication 310 between backend server 300 and client 302. Any suitable authentication schemes and encryption may be used. In an embodiment, communication 306 uses OAuth 2.0 for authentication and SSL for encryption, communication 308 uses mutual SSL for encryption, and communication 310 uses TLS 1.2 for encryption and JSON Web Tokens for authentication. The client 302 may communicate with an additional server (e.g. third, party server) 312 using communication 314. The communications between the client 302 and server 312 may be encrypted using the encryption key 18. Thus, the communications between the client 302 and server 312 may be encrypted using TLS 1.2 and, for example AES 256. Other encryption may be used, and additional encryption may also be used. In an example, TLS 1.2 may be used. In an example, encryption key 18 and decryption key 20 may be an encryption key for AES 256 encryption. In an example, the first information is an encryption key for AES256. Thus, in an example, a communication between a client and a first party server may be triply encrypted, first at peer level with AES 256, with the first information as the decryption key, second at app level, with decryption key 20, and third at a transport level, using SSL.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A method of communicating secret information from a first client to a second client, comprising the steps of:
the first client receiving an encryption key from a key generating server;
the second client receiving a decryption key from the key generating server;
the first client generating first information and second information that in combination represent the secret information;
the first client encrypting the first information with the encryption key to generate encrypted information;
the first client sending the second information to a relaying server;
the second client receiving the second information from the relaying server;
the first client sending the encrypted information to the second client via a communication channel independent of the relaying server and key generating server;
the second client receiving the encrypted information;
the second client decrypting the encrypted information using the decryption key to recover the first information; and
the second client combining the first information and the second information to recover the secret information.

2. The method of claim 1 in which the communication channel independent of the relaying server and key generating server is a third party server.

3. The method of claim 1 in which the relaying server and key generating server are controlled by a single party.

4. The method of claim 1 in which the encryption key and the decryption key are identical.

5. The method of claim 1 which the first information is an additional decryption key and the second information is a file encrypted so that the additional decryption key may be used to decrypt the second information to recover the secret information.

6. The method of claim 5 in which an additional encryption key is used to produce the second information.

7. The method of claim 6 in which the additional decryption key is the additional encryption key.

8. The method of claim 5 in which no other encrypted files are produced that may be decrypted using the additional decryption key.

9. A combination of a first non-transient computer readable medium containing program instructions for causing a first computer to carry out the steps of:
receiving an encryption key from a key generating server;
generating first information and second information that in combination represent secret information;
encrypting the first information with the encryption key to generate encrypted information;
sending the second information to the second computer via a relaying server;
sending the encrypted information to a second computer via a communication channel independent of the relaying server and the key generating server;
and a second non-transient computer readable medium containing program instructions for causing the second computer to carry out the steps of:
receiving a decryption key from the key generating server;
receiving the encrypted information;
receiving the second information from the relaying server;
decrypting the encrypted information using the decryption key to recover the first information; and
combining the first information and the second information to recover the secret information.

10. The combination of claim 9 in which the communication channel independent of the relaying server and key generating server is a third party server.

11. The combination of claim 9 in which the relaying server and key generating server are controlled by a single party.

12. The combination of claim 9 in which the second non-transient computer readable medium is the first non-transient computer readable medium.

13. The combination of claim 9 in which the encryption key and the decryption key are identical.

14. The combination of claim 9 in which the instructions for causing the first computer to generate the first information and second information comprise instructions for encrypting the secret information to produce the second information, the first information being an additional decryption key that may be used to decrypt the second information to recover the secret information.

15. The combination of claim 14 in which an additional encryption key is used to produce the second information.

16. The combination of claim 15 in which the additional decryption key is the additional encryption key.

17. The combination of claim 14 in which no other encrypted files are produced that may be decrypted using the additional decryption key.

18. A method of facilitating communication of secret information between a first client and a second client, the method comprising the steps of:
generating an encryption key and a decryption key;
sending the encryption key to the first client;
sending the decryption key to the second client;
causing the first client to:
generate first information and second information that in combination represent the secret information;
encrypt the first information using the encryption key to produce encrypted information;
send the second information to a server; and
send the encrypted information to the second client via a communication channel independent of the server; and
at the server, sending the second information to the second client.

19. The method of claim 18 in which the communication channel independent of the server is a third party server.

20. The method of claim 18 in which the encryption key and the decryption key are identical.

21. The method of claim 18 in which the first information is a second decryption key and the second information is a file encrypted so that the second decryption key may be used to decrypt the second information to recover the secret information.

22. The method of claim 21 in which an additional encryption key is used to produce the second information.

23. The method of claim 21 in which the second decryption key is the second encryption key.

24. The method of 21 in which no other encrypted files are produced that may be decrypted using the second decryption key.
